(19) United States
(12) Patent Application Publication
(10) Pub. No.: US 2026/0209013 A1
(43) Pub. Date: Jul. 23, 2026

(54) SERVO HOIST SYSTEM INCLUDING SLIDABLE AND ROTATABLE SPOOL

(71) Applicant: Knight Industries & Associates, Inc., Auburn Hills, MI (US)

(72) Inventor: James Zaguroli, JR., Auburn Hills, MI (US)

(21) Appl. No.: 19/033,716

(22) Filed: Jan. 22, 2025

(51) Int. Cl. B66D 3/26; B66C 19/00; B66D 3/20

(52) U.S. Cl. CPC B66D 3/26; B66D 3/20; B66C 19/00

(57) ABSTRACT

A hoist system may include a rotatable shaft, a spool, and a lifting line. The lifting line may be configured to couple to a load. Further, the lifting line may be configured to be wrapped and unwrapped relative to the spool to adjust a position of the load. Additionally, when the shaft rotates, the spool may be configured to rotate together with the shaft and simultaneously slide along the shaft.

### TECHNICAL FIELD

This disclosure relates to a servo hoist system including a slidable and rotatable spool.

### BACKGROUND

Servo hoist systems are lifting systems that use servo motors to provide precise and responsive control of lifting operations. Servo hoist systems are commonly used in industrial, medical, and other specialized applications. In industrial applications, servo hoist systems are used to position heavy workpieces in relation to machining tools (e.g., lathes, milling machines, or welding systems).

### SUMMARY

In some aspects, the techniques described herein relate to a system, including: a rotatable shaft; a spool; and a lifting line, wherein the lifting line is configured to couple to a load, wherein the lifting line is configured to be wrapped and unwrapped relative to the spool to adjust a position of the load, and wherein, when the shaft rotates, the spool is configured to rotate together with the shaft and simultaneously slide along the shaft.

In some aspects, the techniques described herein relate to a system, further including: a bearing, wherein the bearing is configured to interface with the spool such that rotation of the spool results in sliding of the spool along the shaft.

In some aspects, the techniques described herein relate to a system, further including: a housing surrounding the spool and shaft, wherein the bearing is rigidly mounted to the housing.

In some aspects, the techniques described herein relate to a system, further including: a guide configured to guide the lifting line in and out of an opening in the housing and relative to the spool, wherein the guide is arranged such that a feed point of the lifting line is spaced-apart from the bearing.

In some aspects, the techniques described herein relate to a system, wherein the guide is rigidly mounted to the housing.

In some aspects, the techniques described herein relate to a system, wherein the housing includes a cylindrical section surrounding the spool, and wherein the bearing is rigidly mounted to the cylindrical section.

In some aspects, the techniques described herein relate to a system, wherein the spool is cylindrically-shaped.

In some aspects, the techniques described herein relate to a system, wherein: the spool includes a helical groove formed in an outer surface thereof, the lifting line is configured to be received in the helical groove, and the bearing interfaces with the helical groove to translate rotation of the spool into sliding movement of the spool along shaft.

In some aspects, the techniques described herein relate to a system, wherein the bearing is spaced-apart from a feed point of the lifting line.

In some aspects, the techniques described herein relate to a system, wherein: the shaft includes at least one longitudinal groove, the spool is mounted to a slider including at least one projection, the at least one projection is received in the at least one groove such that the spool and shaft are configured to rotate together with one another and such that the spool and slider are able to slide along the shaft.

In some aspects, the techniques described herein relate to a system, wherein the lifting line is one of a cable or a chain.

In some aspects, the techniques described herein relate to a system, wherein a diameter of the spool is within a range of 5 inches to 7 inches.

In some aspects, the techniques described herein relate to a system, wherein a length of the spool is within a range of 7 inches to 9 inches.

In some aspects, the techniques described herein relate to a system, further including: a motor, wherein the motor is coupled to the shaft.

In some aspects, the techniques described herein relate to a system, further including: a drive gear coupled to the motor, a driven gear coupled to the shaft, a chain or belt coupling the drive gear and the driven gear.

In some aspects, the techniques described herein relate to a system, wherein the motor is a servo motor.

In some aspects, the techniques described herein relate to a system, wherein a feed point of the lifting line remains in a substantially constant position while the shaft and spool move.

In some aspects, the techniques described herein relate to a system, including: a rotatable shaft; a spool configured to rotate together with the shaft while simultaneously sliding along the shaft; and a lifting line, wherein the lifting line is configured to couple to a load, wherein the lifting line is configured to be wrapped and unwrapped relative to the spool to adjust a position of the load, and wherein a feed point of the lifting line remains in a substantially constant position while the shaft and spool move.

In some aspects, the techniques described herein relate to a method, including: adjusting a position of a lifting line by wrapping or unwrapping the lifting line relative to a spool of a hoist system, wherein the spool is configured to rotate together with a shaft and simultaneously slide along the shaft.

In some aspects, the techniques described herein relate to a method, wherein a feed point of the lifting line remains in a substantially constant position during the adjusting step.

### BRIEF DESCRIPTION OF THE DRAWINGS

FIG. 1 illustrates an example servo hoist system.

FIG. 2 is a bottom perspective view of an example hoist.

FIG. 3 is a view of a portion of the hoist with a guide removed. In FIG. 3, a feed point of a lifting line and an arrangement of a bearing relative to a spool is visible.

FIG. 4 is a side perspective view of the hoist, with a side of the housing removed.

FIG. 5 is a cross-sectional view taken along line 5-5 and illustrates an example arrangement of the spool relative to a shaft of the hoist.

FIG. 6 is a cross-sectional view illustrating an example interface between the shaft and a slider.

FIG. 7 is a partial view of the hoist with a lifting line in a fully unwrapped state.

FIG. 8 is a partial view of the hoist with the lifting line in a fully wrapped state.

### DETAILED DESCRIPTION

This disclosure relates to a servo hoist system including a slidable and rotatable spool. Among other benefits, this disclosure balances a load relative to a support structure, such as an overhead rail, and minimizes, if not eliminates, slipping or binding of a lifting line as the lifting line wraps and unwraps relative to the spool.

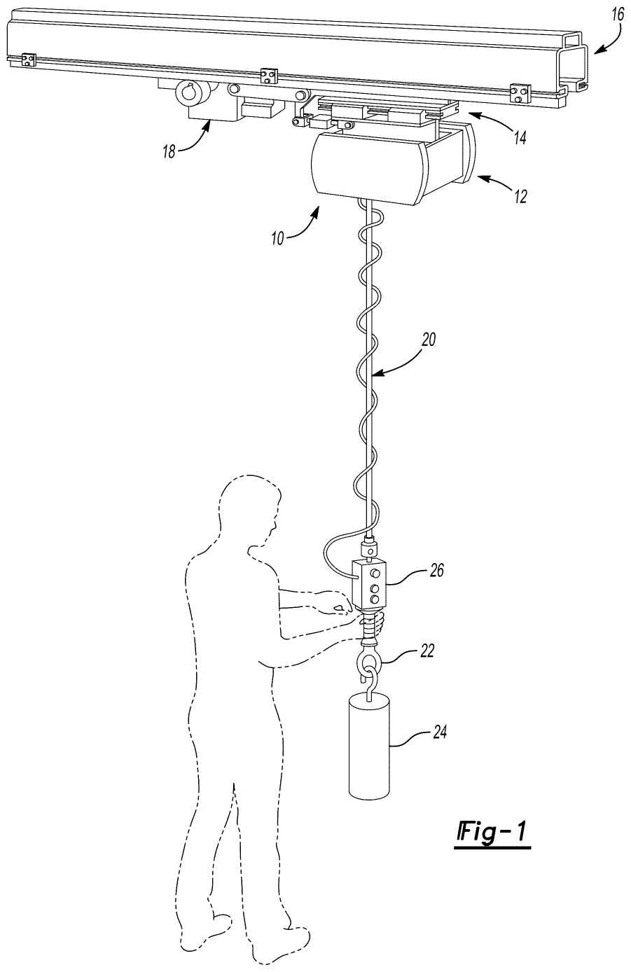

FIG. 1 illustrates an example servo hoist system 10 (“system 10”). The system 10 includes an upper hoist assembly 12 (“hoist 12”) mounted on a trolley 14. The trolley 14 can traverse an overhead rail 16, driven by a trolley drive 18, which can move the hoist 12 when activated. The overhead rail 16 can be provided by a beam or a jib arm of a jib crane, as examples. In some examples, a trolley 14 and the corresponding trolley tractor drive 18 are not present. In those examples, the hoist 12 is mounted to the overhead rail 16 directly.

A lifting line 20, which is moveable by the hoist 12, raises or lowers a load 24. The lifting line 20 is one of a cable or a chain. The lifting line 20 is attached to a lifting eye 22, which supports the load 24, in this example. A control box 26 permits a user to control the hoist 12. The control box 26 includes a number of buttons, and the user is able to control the hoist 12 via those buttons. The control box 26 is mounted to the lifting line 20 and the lifting eye 22 in this example. The user may control the hoist 12 via one or more inputs that are separate from the control box 26, in other examples. Further, the control box 26 may be spaced-apart from the lifting line 20 and lifting eye, in other examples.

The hoist 12 is operable in two control modes, in this example. A first example control mode is a float mode, in which the load 24 remains stationary under its own weight. In the float mode, a user, for example, pushing or pulling directly on the load 24 causes the lifting line 20 to move up or down, raising or lowering the load 24 in response to the applied forces. A second example control mode is a manual mode. When in the manual mode, the user pressing a certain button on the control box 26, for example, causes hoist 12 to adjust a position of the lifting line 20 and, in turn, the load 24.

Control signals generated by components within the control box 26 are transmitted to the hoist 12, which includes a suitably programmed controller. This controller governs the activation of the electro-mechanical components of the hoist 12. The controller includes electronics, software, or both, to perform the necessary control functions for operating the hoist 12 and executing various functions of the hoist 12. The controller may include a single hardware device, or alternatively may include include multiple controllers in the form of multiple hardware devices, or multiple software controllers within one or more hardware devices.

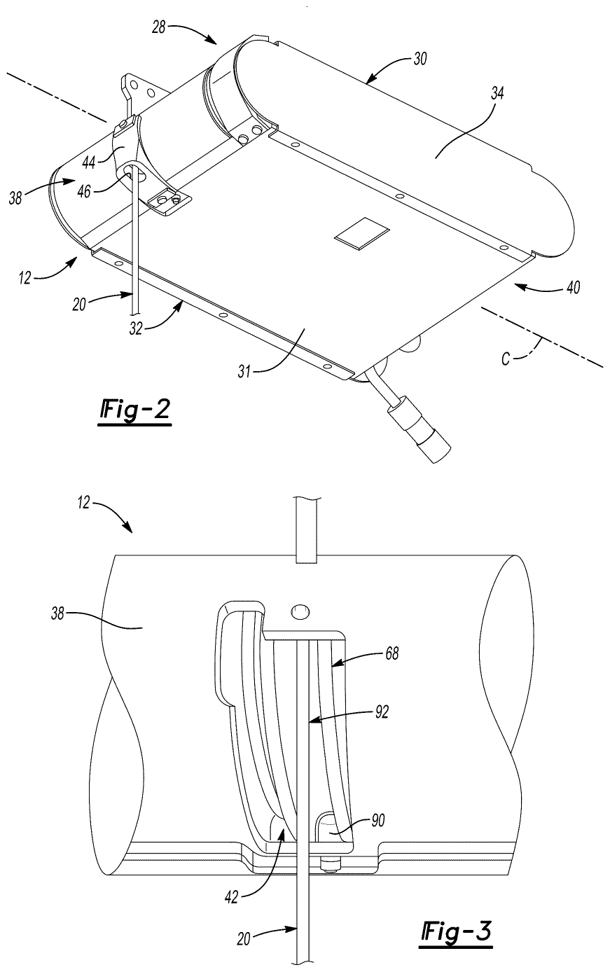

FIG. 2 illustrates an exterior of the hoist 12 from a bottom perspective. The hoist 12 includes an exterior housing 28 (“housing 28”) provided by one or more connected panels. In this example, the housing 28 includes a top 30, bottom 31 opposite the top 30, a first side 34, a second side 36 opposite the first side 34, a front 38, and a back 40 opposite the front 38, forming a defined interior space. The directional terms “top” and “bottom,” for example, are used with reference to the orientation of the hoist 12 in FIG. 2. The first side 34, second side 36, front 38, and a back 40 extend vertically between the top 30 and bottom 31. The configuration of the hoist 12, as described herein, permits a vertical height between the top 30 and bottom 31 to be reduced relative to prior hoist designs.

With reference to FIGS. 2 and 3, the exterior of the housing features an opening 42 (FIG. 3) formed in the front 38. The opening 42 is covered by guide 44 in FIG. 2. The guide 44 is configured to facilitate movement of the lifting line 20 in and out of an interior of the housing 28. The guide 44 includes an opening 46 oriented in a downward direction, relative to the orientation of the hoist 12 in FIG. 2. The openings 42 and 46 are arranged along a centerline C of the housing 28. The centerline C is halfway between first and second sides 32, 34. The guide 44 is rigidly mounted to the housing 28 and is not configured to slide or move during operation of the hoist 12. A mounting bracket 48 is configured to facilitate mounting the housing 28 to the trolley 14 and/or the rail 16 is also arranged on the centerline C. The arrangement of the openings 42, 46 and the mounting bracket 48 on the centerline C allows the hoist 12 and load 24 to remain balanced relative to one another and relative to the rail 16 during operation of the hoist 12.

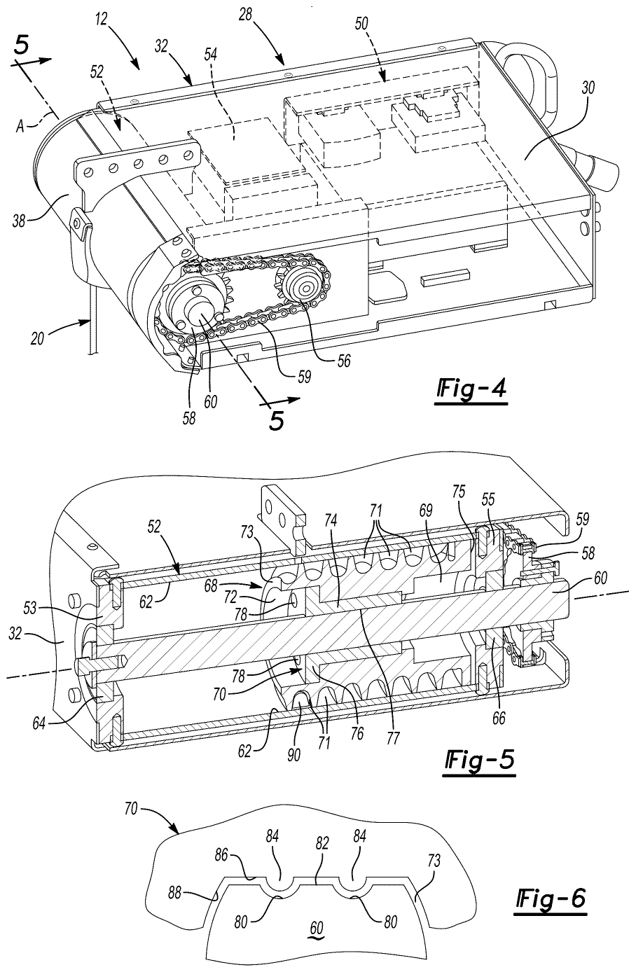

FIG. 4 illustrates the hoist 12 with the side 34 removed, for ease of viewing the interior of the housing 28. In this example, the housing 28 defines two interior compartments. A first compartment 50 includes a number of electronics and electromechanical components of the hoist 12. The housing 28 further includes a cylindrical housing section 52, which is substantially cylindrically-shaped and extends from a location adjacent the first side 32 to a location adjacent the second side 34. The cylindrical housing section 52 defines a cylindrically-shaped compartment that is separate from the first compartment 50. A portion of the cylindrical housing section 52 defines the front 38.

Detail of the components of the hoist 12 that affect movement of the lifting line 20, and in turn the load 24, will now be provided. In this example, the hoist 12 includes a motor 54. The motor 54 may be a servo motor. The motor 54 is activatable in response to inputs from a user, which may be provided via control box 26, for example.

The motor 54 is coupled to a chain drive, in this example. The motor 54 could be coupled to a belt drive system, including a toothed belt instead of a chain, or a gear drive system, in other examples.

The motor 54 includes an output shaft directly coupled to a drive gear 56. The drive gear 56 is coupled to driven gear 58 via a chain 59. The drive gear 56 and driven gear 58 are configured as sprockets in this example. A gear ratio between the drive gear 56 and driven gear 58 is selected based on the torque rating of motor 54 and the expected weight of the load 24.

The driven gear 58 is directly coupled to a shaft 60, and is configured to rotate the shaft 60. The shaft 60 includes a central longitudinal axis A (“axis A”) and projects into the compartment defined by the cylindrical housing section 52, as shown in FIG. 5. Axis A extends substantially perpendicular to centerline C.

With reference to FIG. 5, the cylindrical housing section 52 is provided by one or more walls extending from a location adjacent the first side 32 to a location adjacent the driven gear 58. The cylindrical housing section 52 includes an inner surface 62 facing toward the shaft 60. The shaft 60 is rotatably supported adjacent ends of the cylindrical housing section 52 via rotary bearing assemblies 64, 66. The cylindrical housing section 52 is enclosed at axial ends by caps 53, 55.

A spool 68 is mounted relative to the shaft 60 via a slider 70. As will be discussed below, the spool 68 is mounted relative to the shaft 60 such that the spool 68 simultaneously slides along the shaft 60 while rotating together with the shaft 60 to facilitate wrapping and unwrapping of the lifting line 20 relative to the spool 68.

The lifting line 20 is wrapped and unwrapped relative to the spool 68 to adjust a position of the lifting line 20, an in turn the load 24. In this example, an outer surface of the spool 68 includes a helical groove 71 extending substantially from a first axial end 73 of the spool 68 to a second axial end 75. In this disclosure, the helical groove 71 is configured to receive one length of the lifting line 20. In other words, the lifting line 20 is not intended to be wrapped more than once about the spool 68.

The spool 68 is cylindrically-shaped, and is sized and shaped to fit relatively snugly within the cylindrical housing section 52, while being able to freely rotate and slide without being encumbered by the cylindrical housing section 52. A relatively small radial gap between an outer surface of the spool 68 and the inner surface 62 facilitates smooth wrapping and unwrapping of the lifting line 20 relative to the spool 68. In an example, the radial gap between the outer surface of the spool 68 and the inner surface 62 is less than a diameter of the lifting line 20.

In a particular example, the spool 68 exhibits an outer diameter within a range between 5 inches and 7 inches, and an axial length within a range between 7 and 9 inches. In a particular example, the spool 68 exhibits an outer diameter of substantially 6 inches and an axial length of substantially 8 inches. This configuration of the spool 68 facilitates about 80 inches of vertical travel of the load 24, which is sufficient for a majority of applications. The spool 68 is made of a plastic material, in one example.

In this example, the spool 68 includes a through-bore 69 receiving the shaft and the slider 70. The through-bore 69 includes a section 72 exhibiting an increased diameter relative to an adjacent section of the through-bore 69.

The slider 70 includes a main body section 74. The slider 70 is arranged radially between the shaft 60 and the spool 68 such that a flange 76 of the slider 70 abuts a radially-extending wall forming a boundary of the section 72. The flange 76 includes a plurality of openings 78, and in one example includes four equally spaced-apart openings, configured to facilitate a connection between the spool 68 and the slider 70, such as by using fasteners such as bolts. This connection between the spool 68 and slider 70 transfers rotation and sliding of the slider 70 to the spool 68.

The slider 70 includes a through-bore 77 receiving the shaft 60. The slider 70 interfaces with shaft 60 such that rotation of the shaft 60 results in rotation of the spool 68, but such that the spool 68 is permitted to slide along shaft 60. An example interface between the shaft 60 and the slider 70 is shown in FIG. 6. In this example, the shaft 60 includes two longitudinal grooves 80 extending along an entire length of the shaft 60. The grooves 80 are parallel to one another and parallel to the axis A. The grooves 80 are provided on a flat 82, extending along the entire length of the shaft 60. Further, an inner diameter of the slider 70 includes two projections 84 sized and shaped substantially similar to grooves 80. The projections 84 are received in the grooves 80. The projections 84 are provided on a flat 86 extending an entire axial length of a radially inner surface of the slider 70. The projections 84 may extend an entire axial length of the slider 70.

While two grooves 80 and two projections 84 are shown, this disclosure extends to interfaces with one or more grooves and one or more projections. That said, providing more than one groove and more than one projection provides for a robust interface between the shaft 60 and the slider 70. For example, while only a top portion of the shaft 60 and slider 70 is shown in FIG. 6, the shaft 60 and slider 70 could include a similar interface adjacent a bottom of the shaft 60 and slider 70, for a total of four grooves and four projections. Further, while flats 82, 86 are shown, this disclosure extends to interfaces without flats. Further, when present, the flats 82, 86 also permit relative sliding of the slider 70 and the shaft 60 without permitting relative rotation between the slider 70 and the shaft 60. Having multiple grooves, projections, and flats is not required, but, when present, provides a robust interface. Further still, while the grooves 80 are arranged on shaft 60 and the projections are arranged on slider 70, this disclosure extends to arrangements in which the grooves are provided in the slider 70 and the projections are provided on the shaft 60. Additionally, while the slider 70 and spool 68 are shown as separate structures, the slider 70 could be integrated into spool 68.

As the shaft 60 rotates about axis A, rotation of the shaft 60 is transmitted to the slider 70 via the interface of FIG. 6, which is then transmitted to rotation of the spool 68 via the rigid connection between the slider 70 and spool 68. As such, rotation of the shaft 60 results in corresponding rotation of the spool 68 and slider 70.

The spool 68 is also configured to slide along the shaft 60 simultaneous with rotation of the spool 68. In other words, as the shaft 60 rotates about axis A, the spool 68 rotates together with the shaft 60 about axis A and slides along the shaft 60 along axis A. In this disclosure, rotation of the spool 68 results in sliding of the spool 68 because of bearing 90. Bearing 90 is a rigid structure projecting from inner surface 62 and into helical groove 71. The bearing 90 may be made of a metallic material, in one example. Bearing 90 is rigidly mounted to cylindrical housing section 52 and is not configured to move during operation of the hoist 12. As such, rotation of the spool 68 bring the helical groove 71 into engagement with the bearing 90, which results in sliding of the spool 68 along the shaft 60, via the interface of FIG. 5. Specifically, the projections 84 and grooves 88 permit relative sliding of the slider 70 (and in turn the spool 68) and the shaft 60 without permitting relative rotation between the slider 70 (and in turn the spool 68) and the shaft 60. While a single bearing 90 is shown, this disclosure extends to arrangements with one or more bearings interacting with the helical thread 71.

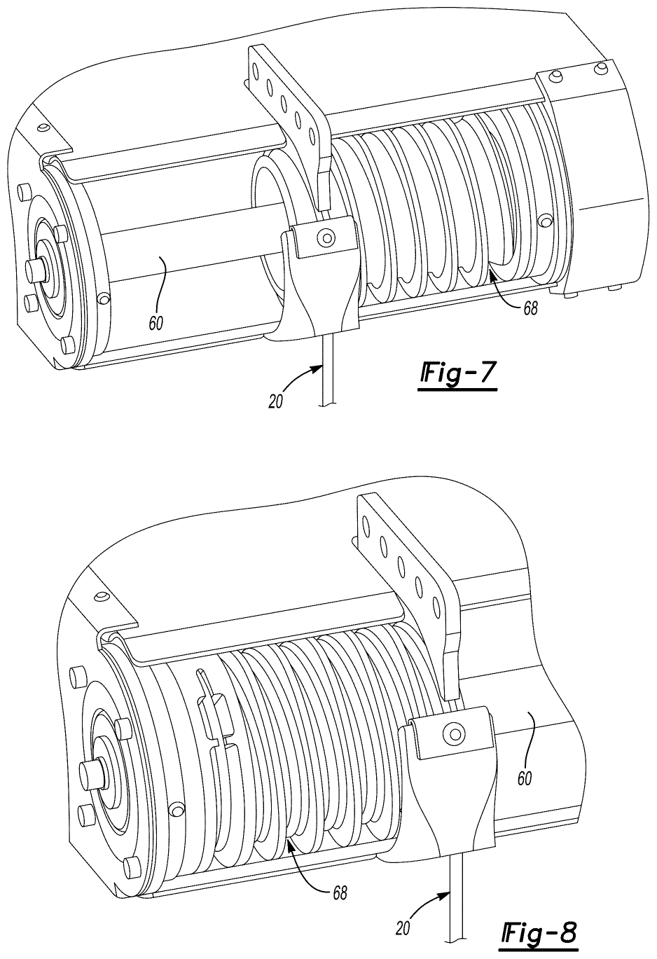

Motor 54 can be activated to selectively wrap and unwrap the lifting line 20 relative to the spool 68. FIG. 7 illustrates the lifting line 20 in a fully unwrapped state, and FIG. 8 illustrates the lifting line 20 in a fully wrapped state. The spool 68 has traveled substantially an entire axial distance between caps 53, 55 between the two states. Because of the arrangement described above, a feed point of the lifting line 20 remains in a constant position as the lifting line 20 is wrapped and unwrapped.

With reference to FIG. 3, a feed point 92 of the lifting line 20 relative to the spool 68 is visible. In this disclosure, the feed point 92 is the point where the lifting line 20 is fed onto or drawn from the spool 68. The feed point 92 is spaced-apart from the bearing 90 such that the bearing 90 does not interfere with wrapping or unwrapping of the lifting line 20 relative to the spool 68. In this example, the bearing 90 is spaced-apart circumferentially from the feed point 92. In particular, the feed point 92 and bearing 90 are spaced-apart by substantially 90° about axis A. Again, the configuration described above permits the feed point 92 to remain in a substantially constant position during operation of the hoist 12, which has a number of benefits, including centering the load 24 relative to hoist 12 and the rail 16, for example.

It should be understood that directional terms have been used herein for purposes of explanation and with reference to the orientation of the drawings, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system, comprising:
a rotatable shaft;
a spool; and
a lifting line, wherein the lifting line is configured to couple to a load, wherein the lifting line is configured to be wrapped and unwrapped relative to the spool to adjust a position of the load, and wherein, when the shaft rotates, the spool is configured to rotate together with the shaft and simultaneously slide along the shaft.

2. The system as recited in claim 1, further comprising:
a bearing, wherein the bearing is configured to interface with the spool such that rotation of the spool results in sliding of the spool along the shaft.

3. The system as recited in claim 2, further comprising:
a housing surrounding the spool and shaft, wherein the bearing is rigidly mounted to the housing.

4. The system as recited in claim 3, further comprising:
a guide configured to guide the lifting line in and out of an opening in the housing and relative to the spool,
wherein the guide is arranged such that a feed point of the lifting line is spaced-apart from the bearing.

5. The system as recited in claim 4, wherein the guide is rigidly mounted to the housing.

6. The system as recited in claim 4, wherein the housing includes a cylindrical section surrounding the spool, and wherein the bearing is rigidly mounted to the cylindrical section.

7. The system as recited in claim 6, wherein the spool is cylindrically-shaped.

8. The system as recited in claim 2, wherein:
the spool includes a helical groove formed in an outer surface thereof,
the lifting line is configured to be received in the helical groove, and
the bearing interfaces with the helical groove to translate rotation of the spool into sliding movement of the spool along shaft.

9. The system as recited in claim 8, wherein the bearing is spaced-apart from a feed point of the lifting line.

10. The system as recited in claim 1, wherein:
the shaft includes at least one longitudinal groove,
the spool is mounted to a slider including at least one projection,
the at least one projection is received in the at least one groove such that the spool and shaft are configured to rotate together with one another and such that the spool and slider are able to slide along the shaft.

11. The system as recited in claim 1, wherein the lifting line is one of a cable or a chain.

12. The system as recited in claim 1, wherein a diameter of the spool is within a range of 5 inches to 7 inches.

13. The system as recited in claim 1, wherein a length of the spool is within a range of 7 inches to 9 inches.

14. The system as recited in claim 1, further comprising:
a motor, wherein the motor is coupled to the shaft.

15. The system as recited in claim 14, further comprising:
a drive gear coupled to the motor,
a driven gear coupled to the shaft,
a chain or belt coupling the drive gear and the driven gear.

16. The system as recited in claim 14, wherein the motor is a servo motor.

17. The system as recited in claim 1, wherein a feed point of the lifting line remains in a substantially constant position while the shaft and spool move.

18. A system, comprising:
a rotatable shaft;
a spool configured to rotate together with the shaft while simultaneously sliding along the shaft; and
a lifting line, wherein the lifting line is configured to couple to a load, wherein the lifting line is configured to be wrapped and unwrapped relative to the spool to adjust a position of the load, and wherein a feed point of the lifting line remains in a substantially constant position while the shaft and spool move.

19. A method, comprising:
adjusting a position of a lifting line by wrapping or unwrapping the lifting line relative to a spool of a hoist system, wherein the spool is configured to rotate together with a shaft and simultaneously slide along the shaft.

20. The method as recited in claim 19, wherein a feed point of the lifting line remains in a substantially constant position during the adjusting step.
